(19) United States
(12) Patent Application Publication
(10) Pub. No.: US 2006/0242344 A1
(43) Pub. Date: Oct. 26, 2006

(54) Electronic device to which memory module can be added

(75) Inventor: Katsutoshi Daikoku, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/373,586

(22) Filed: Mar. 10, 2006

(30) Foreign Application Priority Data
Apr. 11, 2005 (JP) 2005-112991

(51) Int. Cl. G06F 13/00

(52) U.S. Cl. 710/301

(57) ABSTRACT

An electronic device includes a board on which a memory module can be added. An expansion memory and a battery, which supplies power to the expansion memory, are arranged on the memory module.

### BACKGROUND OF THE INVENTION

1. Field of the Invention

The present invention relates to an electronic device such as a facsimile machine, and more specifically, relates to an electronic device including a board on which a memory module can be added.

2. Description of the Related Art

Accompanying a recent informatization, an electronic device which carries out facsimile communication, a copying operation, a printing operation or the like, is required to store a large volume of data. Therefore, assuming a case where data fails to be stored just by a memory loaded as a standard specification, a known electronic device (for example, a printer) can be added with a memory.

Various memories can be installed in such an electronic device. For example, the various memories are memory elements, such as a Dynamic Random Access Memory (DRAM) or a Synchronous Dynamic Random Access Memory (SDRAM). When these memory elements are left, an electric charge of a capacitor leaks and stored data is lost. Thus, these memory elements require a “refresh” in which data is periodically retrieved and written. In the “refresh”, when a memory element is not accessed for a long period of time, for example, when a system is on a standby, a “self-refresh” is applied. In the “self-refresh”, without a control of a peripheral circuit, an address is generated by retrieving from an internal circuit of the DRAM or the SDRAM and the “refresh” is carried out automatically under an optimum interval. In case of the “self-refresh”, power is supplied from a backup battery. Therefore, when a memory is added, power consumption increases accompanying the addition of the memory. As a result, there has existed a drawback of reduction in duration of time when the memory can be backed up.

### SUMMARY OF THE INVENTION

The present invention has been made in order to overcome the problems described above. An advantage of the present invention is to provide an electronic device in which a backup time is not shortened even when a memory is added.

According to a first preferred aspect of the present invention, an electronic device includes a board to which a memory module can be added and connected. The added memory module includes a battery for backing up the memory module. Therefore, even when a memory is added, duration of time when the memory can be backed up is not shorted as in the conventional device. A large-capacity battery is not required to be previously embedded in a main body of the electronic device in an assumption of an addition of the memory module. As a result, the costs of the electronic device can be reduced and a circuitry can be simplified.

According to a second preferred aspect of the present invention, the electronic device includes a charge control circuit, which charges the battery. The battery, which backs up the added memory, includes a charge control circuit which charges the battery itself. As a result, while the electronic device is operating by a commercial power source, the battery can be charged and duration of time when the memory can be backed up can be lengthened even more.

According to a third preferred aspect of the present invention, the added memory module includes an SDRAM. That is, since a memory including the SDRAM can be added, a time of a data processing by the electronic device, i.e., writing and reading of the data, can be speeded up. Further, the SDRAM also includes a Double Data Rate SDRAM (DDR SDRAM).

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating an example of relevant parts of an electronic device according to a preferred embodiment of the present invention.

FIG. 2 illustrates an example of a configuration of a circuit of a memory installed in the electronic device according to a preferred embodiment of the present invention.

FIG. 3A illustrates an example of a circuit for controlling a charge of an added memory module.

FIG. 3B illustrates another example of a circuit for controlling a charge of an added memory module.

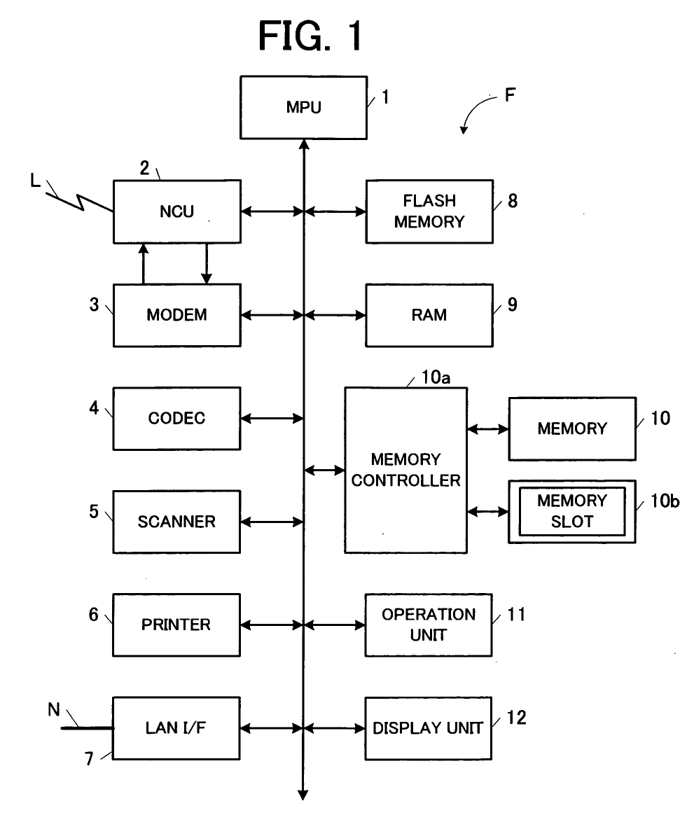

### DETAILED DESCRIPTION OF PREFERRED EMBODIMENTS

A description will be made of preferred embodiments of the present invention. In the drawings, a facsimile machine F is illustrated as an example of an electronic device according to a preferred embodiment of the present invention. However, the electronic device may be a copy machine, a printer machine, a personal computer or the like.

The facsimile machine F includes a Micro Processing Unit (MPU) 1, a Network Control Unit (NCU) 2, a Modulator-Demodulator (MODEM) 3, a Coder-Decoder (CODEC) 4, a scanner 5, a printer 6, a Local Area Network Interface (LAN I/F) 7, a flash memory 8, a RAM 9, a memory 10, an operation unit 11 and a display unit 12. The MPU 1 controls the facsimile machine F. The NCU 2 is connected to a telephone line L. The MODEM 3 modulates and demodulates various signals necessary for facsimile communication. The CODEC 4 encodes and decodes image data. The scanner 5 scans a set original document. The printer 6 prints image data onto previously set printing paper, and outputs the printing paper onto an output tray. The LAN I/F 7 establishes a connection between the facsimile machine F and a LAN N. The flash memory 8 stores a program or the like necessary for the facsimile machine F to operate. The RAM 9 registers a speed dial number or the like. The memory 10 stores image data, which has been encoded from an original document scanned by the scanner 5, and received image data. The operation unit 11 includes various operation keys. The display unit 12 includes a display screen such as a Liquid Crystal Display (LCD). The memory 10 is controlled via a memory controller 10a. The memory controller 10a controls to, for example, adjust timing when writing data in synchronism with a clock signal. When adding a memory, an expansion memory module 15 is inserted into a slot of a memory slot 10b.

The facsimile machine F includes a print circuit board 14 on which the expansion memory module 15 can be installed. The expansion memory module 15 includes memory chips and a battery B2, which backs up the memory chips. The battery B2 is equipped with a charge control circuit 13b. Therefore, while a voltage Vc of a power source line of a circuit board 14 is being applied, the battery B2 can be charged.

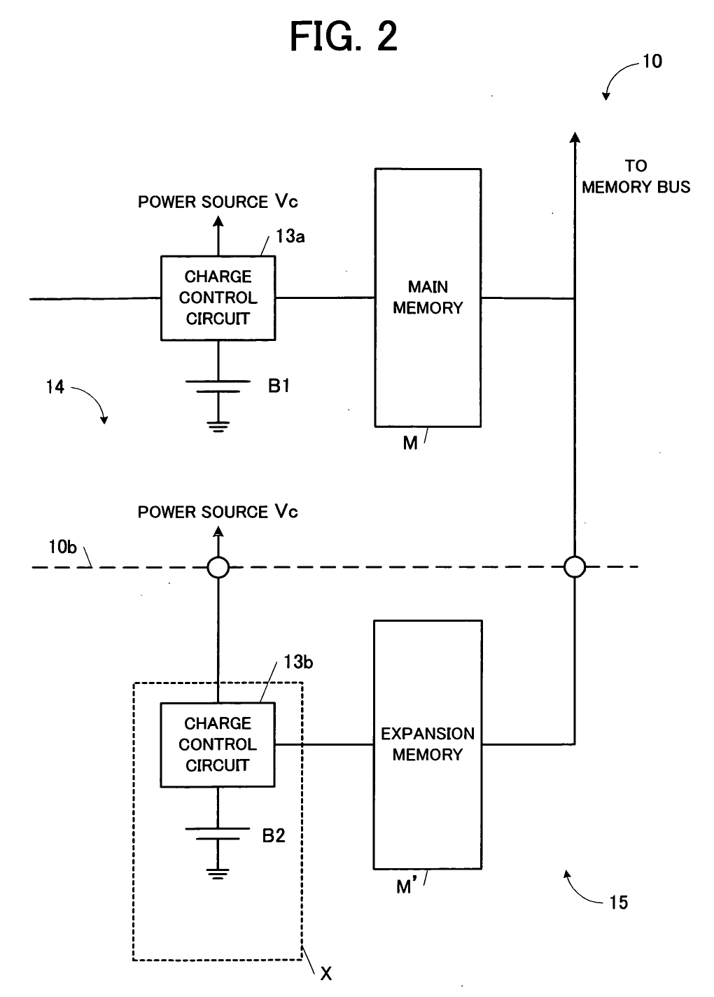

As illustrated in FIG. 2, when a memory has been added to the memory 10, the memory 10 includes a main memory M and an expansion memory M′. The main memory M includes a battery B1 and a charge control circuit 13a, which charges the battery B1. The expansion memory M′ is included in the expansion memory module 15. The expansion memory M′ includes the battery B2, which functions as a backup power source, and the charge control circuit 13b, which charges the battery B2.

A spec of a memory type, a clock frequency, a Column Address Strobe Latency (CL) value or the like of the main memory M and the expansion memory M′ is not to be limited in particular. However, as the memory type, an SDRAM (including a DDR SDRAM) and a DRAM or the like are advantageous in terms of a memory capacity. The expansion memory M′ is selected according to a type of memory chips equipped as the main memory M or according to the main controller 10a and the memory slot 10b. The batteries B1 and B2, which are respectively connected to the charge control circuits 13a and 13b, are a nickel-metal hydride battery, a NiCd battery, or a lithium-ion battery, for example.

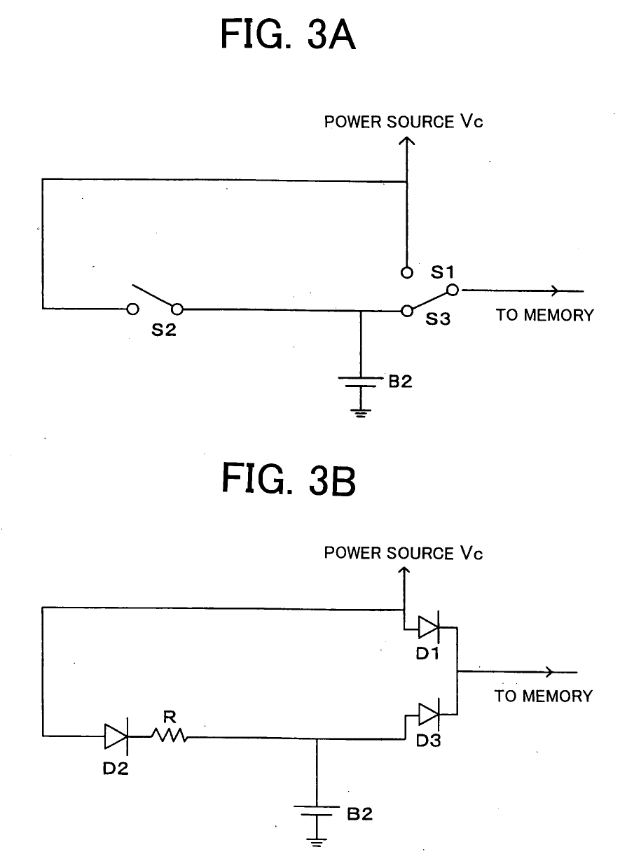

FIGS. 3A and 3B are circuitry diagrams illustrating examples of a configuration of the charge control circuit of a part X indicated in FIG. 2. FIG. 3A illustrates an example of a switch circuit. FIG. 3B illustrates an example of a diode switch circuit. The switch circuit of FIG. 3A includes three terminals, i.e., Single-Pole Double Throw (SPDT) switches S1 and S3 and a Single-Pole Single-Throw (SPST) switch S2. The SPST switch S2 switches on and off a transmission channel. FIG. 3A illustrates a state in which the voltage Vc of the main body of the facsimile machine F is switched off.

The SPDT switch S3 is configured to be switched on in this case. Therefore, when the voltage Vc is switched off, power can be fed to the expansion memory M′ from the battery B2. Meanwhile, when the voltage Vc is switched on, the SPDT switch S1 and the SPST switch S2 are switched on. Accordingly, the backup battery B2 can be charged. Meanwhile, under a state in which the voltage Vc is switched off, even when the expansion memory M′ is self-refreshed and the power is consumed, the battery B2 can be charged when the voltage Vc is switched on. Therefore, even when the expansion memory M′ is added, duration of time when the memory can be backed up is not shortened.

FIG. 3B illustrates an example in which the charge control circuit 13b, in which the same operation as FIG. 3A is performed, includes a diode. The diode switch circuit illustrated in FIG. 3B includes three diodes D1, D2 and D3. The diode D2 is connected to the battery B2 via a protection resistance R. A diode is switched on when the voltage is in a forward direction and switched off when the voltage is in a backward direction.

When the voltage Vc is switched on, an electromotive force is Vc>B2. Accordingly, the diode D2 and the diode D1 are switched on, and an electric current flows from the voltage Vc to the expansion memory M′. Meanwhile, when the voltage Vc is switched off, the electromotive force is Vc<B2. Accordingly, the diode D2 and the diode D1 are switched off, and the diode D3 is switched on. Further, also in the charge control circuit 13b including the diode switches illustrated in FIG. 3B, the same advantageous effects as FIG. 3A can be accomplished.

While the description above refers to particular embodiments of the present invention, it will be understood that many modifications may be made without departing from the scope thereof. The accompanying claims are intended to cover such modifications as would fall within the true scope and spirit of the present invention.

The presently above refers to particular embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An electronic device including a board on which a memory module can be added, the electronic device comprising:
an expansion memory which is arranged on the memory module; and
a battery which is arranged on the memory module and supplies power to the expansion memory.

2. The electronic device according to claim 1, further comprising a charge control circuit which is arranged on the memory module and charges the battery.

3. The electronic device according to claim 2, further comprising a switch which breaks a connection between the battery and a power source line of the board when the power is being supplied from the battery to the expansion memory.

4. The electronic device according to claim 2, further comprising a diode which breaks a connection between the battery and a power source line of the board when the power is being supplied from the battery to the expansion memory.

5. The electronic device according to claim 1, wherein the expansion memory is a Synchronous Dynamic Random Access Memory (SDRAM).

6. The electronic device according to claim 1, further comprising a slot arranged on the board to insert the memory module.

7. An electronic device including a board on which a memory module can be added, the electronic device comprising:
a main memory which is arranged on the board;
a first battery which is arranged on the board and supplies power to the main memory;
a memory module which is added to the board; and
a second battery which is arranged on the memory module and supplies power to a memory on the memory module.

8. The electronic device according to claim 7, further comprising a charge control circuit which is arranged on the memory module and charges the second battery.

9. The electronic device according to claim 8, further comprising a switch which breaks a connection between the second battery and a power source line of the board when the power is being supplied from the second battery to the memory.

10. The electronic device according to claim 8, further comprising a diode which breaks a connection between the second battery and a power source line of the board when the power is being supplied from the second battery to the memory.

11. The electronic device according to claim 7, wherein the memory on the memory module is a Synchronous Dynamic Random Access Memory (SDRAM).

12. The electronic device according to claim 7, further comprising a slot arranged on the board to insert the memory module.
